(19) United States
(12) Patent Application Publication
(10) Pub. No.: US 2025/0193028 A1
(43) Pub. Date: Jun. 12, 2025

(54) AUTHENTICATION ELECTRONIC SYSTEM

(71) Applicant: COMMISSARIAT A L'ENERGIE ATOMIQUE ET AUX ENERGIES ALTERNATIVES, Paris (FR)

(72) Inventors: Florian PEBAY-PEYROULA, Grenoble Cedex 09 (FR); Angélique RASCLE, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 18/972,393

(22) Filed: Dec. 6, 2024

(30) Foreign Application Priority Data
Dec. 7, 2023 (FR) FR2313750

(51) Int. Cl. H04L 9/32

(52) U.S. Cl. CPC H04L 9/3278

(57) ABSTRACT

An electronic authentication system includes a computer, a memory device connected to the computer, and a set of electronic components. The computer and electronic components are connected together by direct or indirect links according to a predetermined configuration, each of the electronic components being provided with a PUF intended to apply a challenge-response type authentication protocol. The electronic system is configured to broadcast a unique challenge to the set of electronic components, and the computer is configured to receive back from the set of electronic components at least one response enabling it to verify the integrity of this set of electronic components by comparing said at least one response with at least one expected response recorded beforehand in the memory device. The integrity of the set of electronic components is authenticated as being valid if the at least one response and the at least one expected response coincide.

### TECHNICAL FIELD OF THE INVENTION

The invention relates to the field of data security, and in particular to that of system equipped with electronic components and wherein a great security of the processed data is required.

### PRIOR ART

An electronic system may comprise several sensor-type electronic components which could measure physical parameters from which it is possible to extract information, or functions, considered as critical or sensitive.

For example, extended-reality glasses include several sensors intended to measure parameters that might be confidential. Thus, it is essential to trust this system and to be sure that all sensors give information originating from the system. Furthermore, it is essential to verify that the system is intact and that there is no doubt on the reliability of the connections between the different electronic components.

Document US 2019/312740 covers the security of sensors based on the use of physical unclonable functions PUF (“Physical Unclonable Function” in English) generated from data of a calibrated first sensor. A non-calibrated second sensor is also used, and the generated PUF is compared with a database of identification PUFs of the sensor. The data used for the generation of the PUF may correspond to physical or chemical signals obtained in the first sensor. This document does not propose securing over the entire operating chain of the system and, more particularly, does not propose verifying the integrity of the system.

Indeed, the electronic components may be very numerous and may be connected together in chain or according to any configuration. Thus, it is essential to be sure that the system is intact meaning that the same components are still present in this system.

Thus, an object of the present invention is to overcome the aforementioned drawbacks by providing an authentication method and an authentication system allowing carrying out a mutual authentication between the different electronic components of the system consequently involving a high level of integrity and reliability of the connections and information between these different electronic components.

### DESCRIPTION OF THE INVENTION

The invention provides an electronic authentication system including a computer, a memory device connected to the computer, and a set of electronic components, the computer and the electronic components are connected together by direct or indirect links according to a predetermined configuration, each of the electronic components being provided with a PUF intended to apply a challenge-response type authentication protocol. The electronic system is configured to broadcast a unique challenge to the set of electronic components, and the computer is configured to receive back from the set of electronic components at least one response enabling it to verify the integrity of this set of electronic components by comparing said at least one response with at least one expected response recorded beforehand in the memory device, the integrity of the set of electronic components being authenticated as being valid if said at least one response and said at least one expected response coincide.

This allows propagating the interrogation of the same challenge simply and rapidly through the set of electronic components allowing carrying out a mutual authentication in pairs between the different electronic components.

It is essential to point out that the use of PUF in each electronic component makes the use of shared secrets useless. Hence, it is not necessary to establish shared secrets in advance between the memory device, the computer and the electronic components.

According to a first embodiment, the computer is configured to recover a set of individual responses from said set of electronic components and to compare it in a bijective manner with a set of expected individual responses specific to said challenge and to said set of electronic components.

Thus, the mutual authentication between the different electronic components may be carried out in a simple manner without adding new functions to the components.

According to a second embodiment, the computer is configured to:
recover a set of individual responses from said set of electronic components,
compute a group response according to said set of individual responses,
compare said group response with an expected group response.

This allows saving time by enabling the computer to interrogate the enrolment database only once while minimising the size of this database.

According to a third embodiment, a specific electronic component amongst the set of electronic components is configured to have a set of representative responses, in explicit or implicit manners, of the set of individual responses, enabling it to compute and transmit a group response to the computer which is configured to compare said group response with an expected group response.

This allows minimising the interrogation consumption of the enrolment database and enables the computer to minimise time by interrogating only the specific electronic component to have the group response. Furthermore, any attack against the computer will not succeed to modify the group response computation.

Advantageously, said set of responses, that the specific electronic component has, includes at least one intermediate group response computed by at least one other electronic component.

This allows simplifying the architecture of the system and allows having modules that are easily interchangeable.

According to a fourth embodiment, each of the electronic components is configured to have the set of individual responses enabling it to compute and transmit a group response to the computer which is configured to compare the group response received from any one of the electronic components with an expected group response.

This enables the computer to minimise time by interrogating only one electronic component. Furthermore, in case of unavailability of an electronic component, the computer could interrogate any other electronic component in order to have the group response. In addition, like before, an attack against the computer cannot modify the group response computation.

According to a particular embodiment, the electronic system is configured to use a first encryption key to form a secure link between the computer and at least one electronic component, so-called identification electronic component, amongst the set of electronic components, the computer being configured to transmit a user challenge to the identification electronic component using the secure link, the identification electronic component being configured to carry out a measurement on the user by means of said user challenge and to send, via the secure link, the response of the measurement to the computer which is configured to compare the response of the measurement with an expected identification response recorded beforehand by the memory device, the user being authenticated as valid if the response of the measurement corresponds to the expected identification response.

Thus, by transitivity, the fact that the already validated identification electronic component has authenticated the user, guarantees that all of the electronic components carry out their measurements on the same user. It should be noted that the encryption key is a temporary key that is constructed upon execution of the protocol.

Advantageously, the computer is configured to compute the first encryption key based on said unique challenge and on the individual response of said identification electronic component.

Advantageously, the computer is further configured to:
compute a second encryption key based on said user challenge and said response of the measurement, the second encryption key being shared between the computer and the identification electronic component,
compute a third encryption key based on the first and second encryption keys, the second encryption key being shared between the computer and the identification electronic component,
exchange encrypted data between the identification electronic component and the computer using the third encryption key.

Advantageously, the memory device includes a database remote from the set of electronic components and from the computer.

Advantageously, the set of electronic components and the computer form a portion of an electronic device corresponding to a smartphone, or an electronic watch connected to the Internet, or extended reality glasses connected to the Internet, or a vehicle.

Advantageously, the set of electronic components and the computer are part of a set of electronic devices carried or used by the user.

Advantageously, the set of electronic components and the computer are part of a set of electronic devices corresponding to a set of equipment in a vehicle.

Advantageously, the electronic components correspond to memories held in a printed circuit board PCB.

The invention also relates to a challenge-response type authentication method, implemented in an electronic system according to one of the preceding features.

### BRIEF DESCRIPTION OF THE FIGURES

Other advantages, aims and particular features of the present invention will appear from the following non-limiting description of at least one particular embodiment of the devices and methods according to the present invention, with reference to the appended drawings, wherein:

FIG. 1 illustrates, very schematically, an authentication electronic system, according to an embodiment of the invention;

FIG. 2 illustrates, very schematically, an electronic component corresponding to a sensor, according to an embodiment of the invention;

FIGS. 3-7 illustrate diagrams representing the steps implemented during an authentication of a set of electronic components by the electronic components by the electronic system, according to different embodiments of the invention;

FIG. 8 illustrates, very schematically, an authentication electronic system, according to a particular embodiment of the invention; and

FIG. 9 illustrates a diagram showing the steps implemented during an authentication of a user by the electronic system, according to a preferred embodiment of the invention.

### DETAILED DESCRIPTION OF THE INVENTION

The principle of the invention consists in propagating the same challenge through the electronic components of a system in order to carry out a mutual authentication between the different electronic components in pairs.

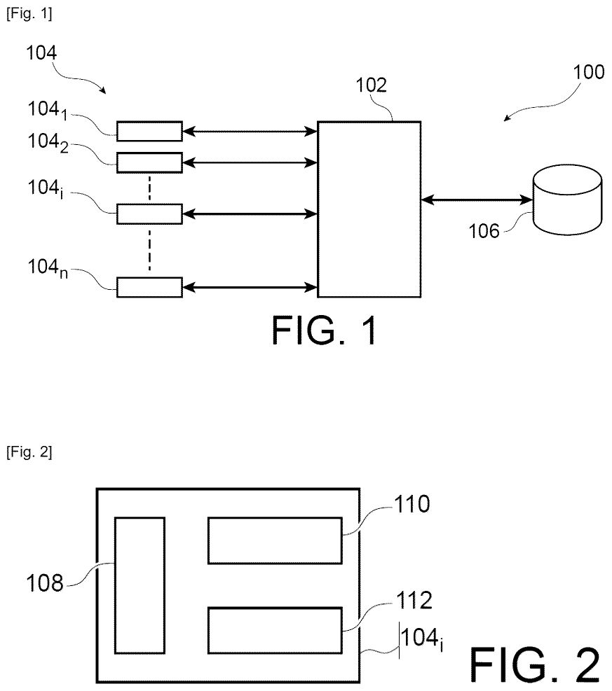

FIG. 1 illustrates, very schematically, an authentication electronic system, according to an embodiment of the invention.

The electronic system 100 includes at least the following elements: a computer 102, a set of electronic components 104 and a memory device 106. The electronic components 104 are referenced 1041, 1042, . . . , 104i, . . . , 104n.

For example, the computer 102 corresponds to a central processing unit CPU “Central Processing Unit”, a microcontroller, an application-specific processor, or any other electronic computing device.

The memory device 106 is connected to the computer 102. According to an advantageous embodiment, the memory device 106 may correspond to a database remote from the computer 102. In this case, the memory device 106 could communicate via a confidential link with the computer 102 via at least one communication network, for example the Internet. Alternatively, the memory device 106 may correspond to a local memory part of a device including the electronic components 104 and the computer 102 and communicating, for example, with the computer 102 without passing through a network external to the device.

The computer 102 and the electronic components 104 are connected together via direct or indirect links according to a predetermined configuration. In general, the computer 102 and the electronic components 104 form a more or less complex circuit where each element (i.e. electronic component or computer) can be directly connected to any number of other elements. For example, these elements may be connected sequentially according to a chain where each element is connected at most to two other elements. Another example is the case of a circuit where each element is connected to all of the other elements.

Each electronic component 104i comprises a “physical unclonable function” PUF intended to apply a challenge-response type authentication protocol. The PUF may be obtained using one or more constituent(s) of the electronic component 104. The electronic component 104i may correspond to a sensor, a memory, an actuator, etc.

The PUF used in each electronic component 104 may indifferently belong to one of the two large families of PUFs, namely weak PUFs and strong PUFs. If the selected PUF is a strong PUF, the authenticator generates a challenge ‘challenge’ C, it is sent to the PUF which generates a response R (specific to C). This response is sent back to the authenticator for comparison with the expected response. This has the advantage of doing without cryptography and secrets shared beforehand. In the case of a weak PUF, the authenticator challenges the PUF by asking it for its key, the PUF sends back the response R (which is its set key or a derived piece of information). In the following description, the case of strong PUFs is considered bearing in mind that it can be simply transposed to the case of weak PUFs.

FIG. 2 illustrates, very schematically, an electronic component corresponding to a sensor, according to an embodiment of the invention.

In this case, the electronic component 104i is a sensor including a measurement module 108, a digital interface 110, and a volatile memory 112. The measurement module 108 transforms the measured physical, chemical or biological parameter into an analog electrical signal. The digital interface 110 is configured to carry out shaping of the measurement analog signal into a digital signal and ensures the digital communication of this signal towards the computer 102 or another component.

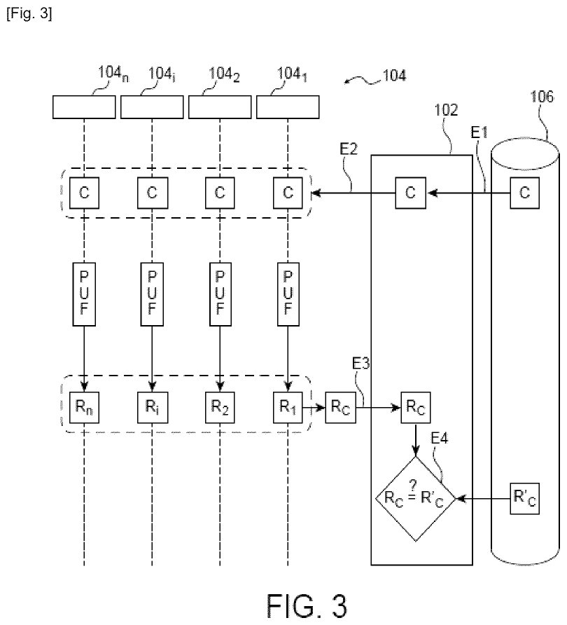

FIG. 3 illustrates a diagram showing the steps implemented during an authentication of a set of electronic components by the electronic system, according to the invention.

During steps E1 and E2, the electronic system 100 is configured to broadcast a unique authentication challenge to the set of electronic components 104 referenced 1041, 1042, . . . , 104i, . . . , 104n. In other words, the challenge C is shared to interrogate all of the electronic components 104 with the latter.

More particularly, in step E1, the computer 102 recovers from the memory device 106, a challenge C which is common to all of the electronic components 104 to be authenticated. Indeed, the computer 102 knows which electronic components 104 compose the set, it could therefore select a challenge C for which the responses of the electronic components 104 to be authenticated are known.

In step E2, the computer 102 is configured to transmit the unique challenge C to at least one electronic component 1041 which computes, thanks to its PUF1, the response R₁ that it stores temporarily. Afterwards, the latter transmits the same challenge C to at least one other electronic component 1042 and so on, so that the same challenge C propagates rapidly in the electronic system 100 according to the connection configuration between the different electronic components 104 to reach each of them.

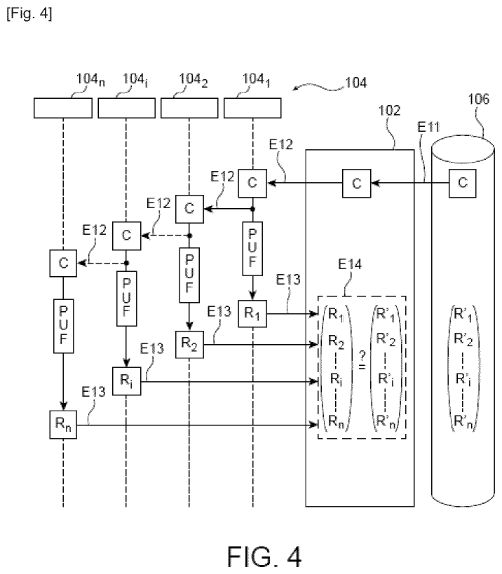

In step E3, the computer 102 is configured to receive from the set of electronic components 104 at least one response R_{c} to the unique challenge C. According to different embodiments (cf. FIGS. 4-7), the set of electronic components 104 may transmit to the computer 102 a unique group response R_{c}=R_{g} or a set of individual responses R_{c}=(R₁, . . . , Rₙ) or a mixture of partial group responses and individual responses.

In step E4, the computer 102 is configured to compare said at least one response R_{c} with at least one expected response R′_{c}, recorded beforehand in the memory device 106. An equivalence between said at least one response R_{c} and said at least one expected response R′_{c} involves a mutual authentication between the different electronic components 104 in pairs. Thus, the integrity of the set of electronic components 104 is authenticated as being valid if said at least one response R_{c} and said at least one expected response R′_{c} coincide.

In order to carry out the authentication of the electronic components 104, an enrolment of these electronic components 104 is implemented at first. For example, the enrolment of the set of electronic components 104 is carried out by sending numerous different challenge data to the set of electronic components 104 and by recording in the memory device 106 the response data sent back by the set of components. In this case, the enrolment of the set of electronic components 104 may correspond to the construction, in the memory device 106, of a table giving, for each of the different challenges, corresponding expected responses. For example, each challenge may correspond to common calibration data with which the electronic components 104 could perform reference measurements.

FIG. 4 illustrates a diagram representing the steps implemented during an authentication of a set of electronic components by the electronic system, according to a first embodiment of the invention.

In step E11, the computer 102 asks the memory device 106 to provide, amongst all of the challenges of the recorded electronic components 104, a challenge C common to all of the electronic components 104 to be authenticated.

In step E12, the computer 102 is configured to send the challenge C to a first electronic component 1041 which transmits it afterwards to a second electronic component 1042 and so on up to the last electronic component 104n. The challenge C is submitted at the input of each electronic component 104i so that the PUF of the electronic component 104i generates an individual response Rᵢ. Each individual response Rᵢ is specific to the corresponding electronic component 104i. It should be noted that the PUFs can compute their responses in parallel (i.e., each at the same time) or in series (i.e., one after another).

In step E13, each electronic component 104i sends its individual response Rᵢ to the calculator 102. Thus, a set of individual responses (R₁, . . . , Rₙ) of the corresponding set of electronic components 1041, 1042, . . . , 104i, . . . , 104n is sent to the computer 102.

In step E14, after recovering the set of individual responses (R₁, . . . , Rₙ) from the set of electronic components 104, the computer 102 is configured to compare in a bijective manner the set of individual responses (R₁, . . . , Rₙ) with a set of expected individual responses (R′₁, . . . , R′ₙ) specific to the challenge C and to the set of electronic components 104. The set of expected individual responses (R′₁, . . . , R′ₙ) is recorded beforehand in the memory device 106.

This first embodiment features a simple architecture and the electronic components remain intrinsically simple without requiring additional functions. However, in case of a very large number of electronic components, this system could possibly involve a relatively large enrolment database.

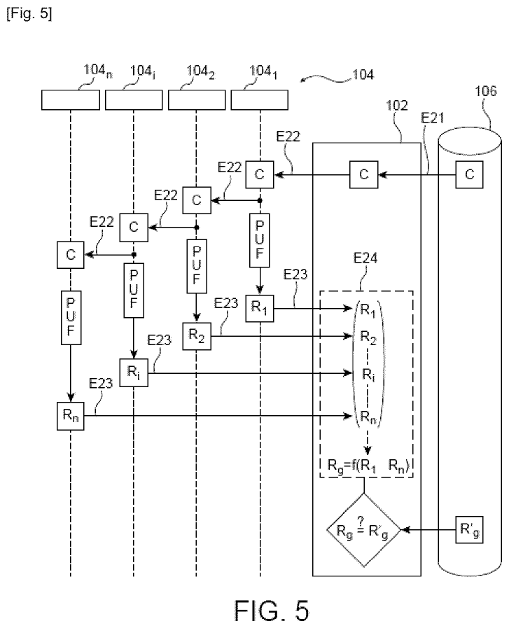

FIG. 5 illustrates a diagram representing the steps implemented during an authentication of a set of electronic components by the electronic system, according to a second embodiment of the invention.

Steps E21-E23 are identical to those of steps E11-E13 of the first embodiment relating to FIG. 4.

In step E24, the computer 102 recovers the set of individual responses (R₁, . . . , Rₙ) from the set of electronic components 104. Thanks to a predetermined function f, the computer 102 is configured to compute a group response R_{g} according to the set of individual responses R_{g}=f(R₁, . . . , Rₙ). For example, the predetermined function f may be a function amongst the following functions: bitwise exclusive or (XOR), concatenation, hash, encryption, addition, etc.

In step E25, the computer 102 is configured to compare the group response R_{g} with an expected group response R′_{g} recorded beforehand by the memory device 106. Thus, the computer 102 interrogates the enrolment database only once instead of several successive times and, consequently, reduces the processing time while minimising the size of this database.

For example, the PUFs of the different electronic components 104 may be enrolled by the manufacturer of the hardware who also provides the group responses. This enables the manufacturer to control the integrity of the electronic components 104.

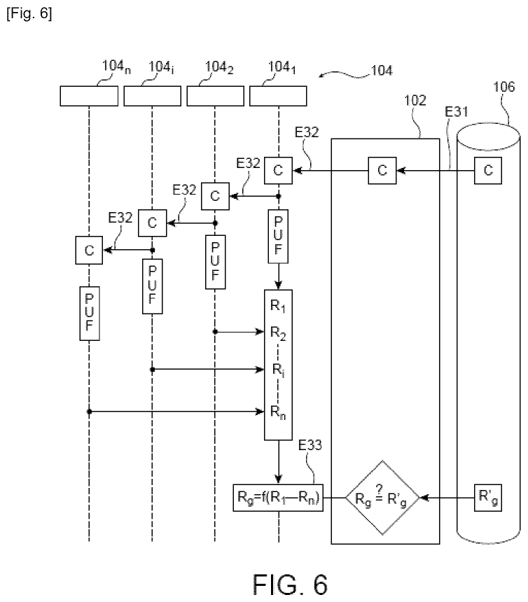

FIG. 6 illustrates a diagram representing the steps implemented during an authentication of a set of electronic components by the electronic system, according to a preferred third embodiment of the invention.

According to this third embodiment, a specific electronic component amongst the set of electronic components 104 is configured to have a set of responses explicitly or implicitly representative of the set of individual responses originating from at least part of the electronic components 104. In this case, the specific electronic component is configured to compute a group response according to the set of responses. The specific electronic component transmits the group response to the computer which is configured to compare the group response with an expected group response.

It should be noted that the set of responses, that the specific electronic component has, may include at least one intermediate group response. The intermediate group response is computed by at least one other electronic component according to its own individual response and a subset of individual responses originating from a corresponding subset of electronic components.

The process according to FIG. 6 refers to the particular case where the specific electronic component has all of the individual responses on the basis of which it computes a group response. In this embodiment, the specific electronic component is referenced by 1041 in FIG. 6.

More particularly, in step E31, the computer 102 recovers from the memory device, a challenge C which is common to all of the electronic components 104 to be authenticated. Indeed, the computer 102 knows which electronic components 104 compose the set, it could therefore select a challenge C for which the individual responses of the electronic components 104 to be authenticated are known. Thanks to a predetermined function f, the computer 102 is configured to compute an expected group response R′_{g} according to the expected individual responses R′_{g}=f(R′₁, . . . , R′ₙ). For example, the predetermined function f may be a XOR function, a concatenation a hash, an encryption, an addition, etc.

In step E32, the computer 102 is configured to transmit the unique challenge C to the specific electronic component 1041, so-called first electronic component 1041, which computes, thanks to its PUF, the individual response R₁ that it stores temporarily. Afterwards, the latter transmits the same challenge to the second electronic component 1042. The second electronic component 1042 computes, thanks to its PUF, the second individual response R₂ that it retransmits to the first electronic component 1041. Furthermore, the second electronic component 1042 transmits, afterwards, the same challenge C to the third electronic component 1043 and so on. This step is repeated on each electronic component 104i. The last electronic component 104n computes, thanks to its PUF, the last individual response Rₙ that it transmits to the first electronic component 1041.

In step E33, the first electronic component 1041 centralises the individual responses R₁, . . . ,Rₙ of the set of electronic components 104 on the basis of which it computes the group response R_{g}=f(R₁, . . . ,Rₙ) that it sends afterwards to the computer 102.

It should be noted that, according to a particular embodiment, the set of responses, that the specific electronic has, may include at least one intermediate group response computed by at least one other electronic component. This intermediate group response may be computed by said at least one other electronic component according to its own individual response and a subset of individual responses originating from a corresponding subset of electronic components. Nonetheless, in the following description relating to FIG. 6, it is considered that the specific electronic component 1041 has individual responses R₁, . . . ,Rₙ.

In step S34, the computer 102 is configured to compare the group response R_{g} with the expected group response R′_{g} recorded beforehand in the memory device 106. If the two responses coincide, the system would have been able to authenticate the set of electronic components 104.

This third embodiment allows minimising the interrogation consumption of the enrolment database and enables the computer 102 to minimise the time by interrogating only the specific electronic component 1041 to have the group response. Furthermore, any attack against the computer 102 will not succeed to modify the computation of the group response.

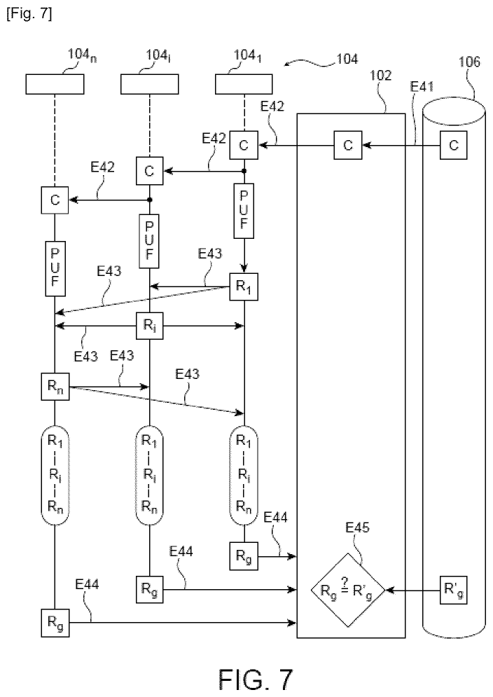

FIG. 7 illustrates a diagram representing the steps implemented during an authentication of a set of electronic components by the electronic system, according to a preferred fourth embodiment of the invention.

Step E41 is similar to step E31 of FIG. 6 in which the computer 102 recovers, from the memory device, a challenge C which is common to all of the electronic components 104 to be authenticated.

In step E42, the computer 102 is configured to transmit the unique challenge to the first electronic component 1041, which computes, thanks to its PUF, the individual response R₁ that it stores temporarily. Afterwards, the latter transmits the same challenge to the second electronic component 1042. The second electronic component 1042 computes, thanks to its PUF, the second individual response R₂ that it stores temporarily and so on.

In step E43, each electronic component 104i transmits its own individual response Rᵢ to all of the other electronic components 104 so that each electronic component 104i has all of the individual responses (R₁, . . . ,Rₙ) enabling it to compute the overall response.

In step E43, each electronic component 104i centralises the individual responses R₁, . . . ,Rₙ of the set of electronic components 104 on the basis of which it computes the overall group response R_{g}=f(R₁, . . . ,Rₙ).

In step E44, each electronic component 104i can transmit its group response R_{g} to the computer 102.

In step E45, the computer 102 can individually verify the group response R_{g} before all of the authenticated electronic components 104 by comparing the group response R_{g} with the expected group response R′_{g}. Thus, in case of unavailability of an electronic component, the computer can use the group response originating from another available electronic component.

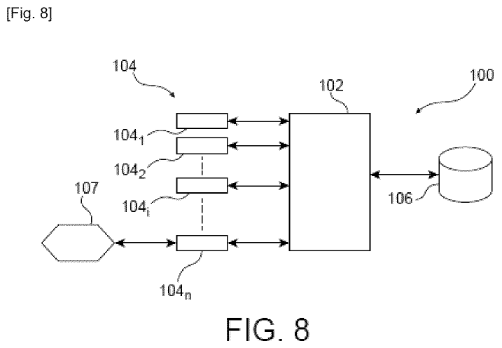

FIG. 8 illustrates, very schematically, an authentication electronic system, according to a particular embodiment of the invention.

This figure differs from FIG. 1 in that the electronic system 100 also takes account of the authentication of a user 107.

Thus, the electronic system 100 includes a computer 102, a set of electronic components 104 and a memory device 106. In FIG. 8, the user is designated by the reference 107.

According to a particular embodiment, at least one of the electronic components 104 is an identification electronic component, corresponding to a biometric sensor like for example a fingerprint sensor. In this case, the identification electronic component is designated by the reference 104n.

This at least one identification electronic component 104n or biometric sensor may be part of an electronic device also including the other electronic components 104 and the computer 102 and with which the user 107 is intended to authenticate or to be authenticated. The electronic device may correspond to a smartphone, or an electronic watch connected to the Internet, or extended-reality glasses connected to the Internet, or a connected vehicle. According to another example, the set of electronic component and the computer may be part of a set of electronic devices carried or used by the user like a smartphone, and/or a connected electronic watch, and/or connected glasses, etc. The set of electronic components and the computer may also be part of a set of electronic devices corresponding to a set of equipment in a vehicle. According to still another example, the electronic components may correspond to memories held in a printed circuit board PCB.

The challenge-response type mutual authentication in pairs of the electronic components has been described hereinabove with reference to FIGS. 3-7. The challenge-response type authentication of the user, implemented by the system 100 is described hereinbelow.

Before carrying out the authentication of the user 107, an enrolment of the user is implemented at first. For example, this enrolment of the user is obtained by carrying out different measurements by the identification electronic component (biometric sensor) 104n and by recording in the memory device 106 the response data corresponding to these authentication measurements of the user 107.

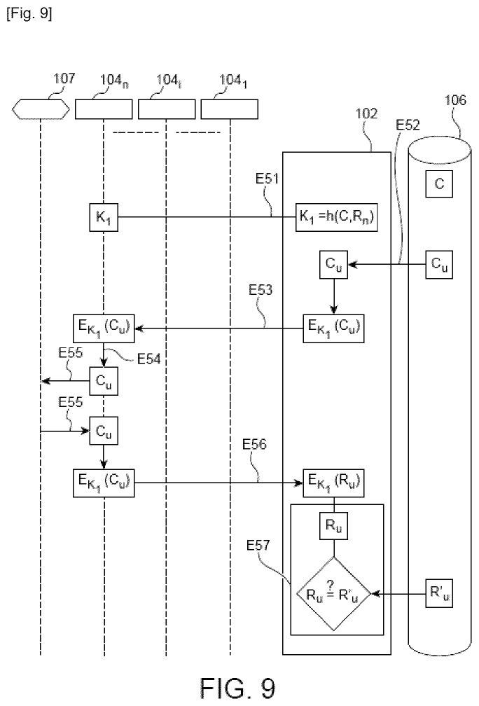

FIG. 9 illustrates a diagram showing the steps implemented during an authentication of a user by the electronic system, according to a preferred embodiment of the invention.

The process of authenticating the user 107 could continue after authentication of all of the electronic components 104 including that of the identification electronic component 104n has been carried out according to any one of the previous embodiments of FIG. 3-7.

At this stage, in step E51, the electronic system 100 is configured to use a first encryption key K₁ to form a secure link between the computer 102 and at least one identification electronic component 104n. The computer 102 computes the first encryption key K₁, for example with a hash function h taking as a parameter the unique challenge C and the individual response Rₙ of the identification electronic component 104n (K₁=C, Rₙ). For example, this function h carries out a concatenation of the data C and Rₙ and a hash function, for example of the SHA-256 type. In FIG. 8, the secure link formed between the computer 102 and the identification electronic component 104n and using the first encryption key K₁ is symbolically designated by the reference 118. Thus, after authentication of the identification electronic component 104n, the data exchanges between the identification electronic component 104n and the computer 102 may be carried out through the secure link 118.

In step E52, the computer 102 recovers challenge data from the user 107, denoted C_{U}, recorded in the memory device 106 and being part of the valid identification data of the user 107 obtained before upon enrolment of the user. For example, in the case of an identification electronic component 104n corresponding to a fingerprint sensor, the user challenge data C_{U} may correspond to a signal controlling the illumination of the finger of the user by the identification electronic component 104n.

In step E53, the computer 102 is configured to transmit the user challenge data C_{U} to the identification electronic component 104n using the secure link 118, i.e. by encrypting these data with the first encryption key K₁. In FIG. 9, the data CU encrypted with the key K₁ are denoted E_{K1}(C_{U}).

In step E54, the identification electronic component 104n decrypts the received message E_{K1}(C_{U}) to reconstruct the unencrypted data C_{U}.

In step E55, the identification electronic component 104n carries out an authentication measurement of the user 107.

In step E56, the response of the measurement, denoted R_{U} in FIG. 9, corresponding to the authentication measurement of the user 107 by the identification electronic component 104n, is sent from the identification electronic component 104n to the computer 102 via the secure link. For this transmission, the data of the response of the measurement R_{U} are encrypted using the first encryption key K₁, these encrypted data being denoted E_{K1}(R_{U}) in FIG. 9.

In step E57, the response of the measurement R_{U} is decrypted by the computer 102, and then compared with an expected identification response R′_{U} recorded beforehand by the memory device 106. The user 107 is authenticated as being valid if the response of the measurement R_{U} corresponds to the expected identification response R′_{U} of the user. Thus, by transitivity, the fact that the already validated identification electronic component 104n has authenticated the user 107, guarantees that all of the electronic components 104 carry out their measurements on the same user 107.

After the challenge-response type authentication of the user 107, a second encryption key K₂ may be computed by the computer 102 based on the challenge data of the user C_{U} and the data of the measurement response R_{U} of the user, for example with the hash function h taking as parameters the data C_{U} and R_{U}. Thus, the computer 102 and the identification electronic component 104n share a key K₁ specific to the pair formed by the identification electronic component 104n and the computer 102 and a key K₂ specific to the user/computer pair.

Afterwards, a third encryption key K₃ may be computed based on the first K₁ and second K₂ encryption keys and shared between the computer 102 and the identification electronic component 104n. For example, this third key K₃ is obtained by carrying out a hashing of the concatenated first and second keys K₁, K₂, or by carrying out an “exclusive or” type operation between the two keys K₁, K₂. Other ways for computing the key K₃ are possible. Afterwards, the computed third key K₃ may be used to exchange encrypted data between the identification electronic component 104n and the computer 102, and guarantee the confidentiality of the data in the processing chain of the system 100. The third key K₃ may be used to encrypt the stored data originating from the identification electronic component 104n, this key K₃ being therefore required to decrypt the encrypted data originating from the identification electronic component 104n.

In a particular embodiment, the computer 102 may use a corrector code in order to be able to regenerate the encryption key used to encrypt the data exchanged between the identification electronic component 104n and the computer 102 in case of disturbances. For example, a “helper data” type element may be included in the computer 102 and the identification electronic component 104n in order to be capable of correcting the extracted data in case of disturbance.

In the computer 102, a secure routine may be executed to interface the computer 102 with the identification electronic component 104n and generate afterwards the encryption key K₃ in a secure manner. Thus, the use of a “Trust Execution Environment” (TEE) type secure enclave could enable the generation, the storage and the use of this key in a secure manner. In the identification electronic component 104n, a dedicated digital circuit may be associated in an integrated circuit of the identification electronic component 104n to extract the authentication data and generate the encryption key K₃ which is stored in an internal register or a secure memory of the identification electronic component 104n.

The electronic system 100 may be configured to implement, periodically or not, and after a first challenge-response type authentication of the user:
another challenge-response type authentication of the identification electronic component 104n, in which the response data of the identification electronic component 104n are intended to be generated by the PUF of the identification electronic component 104n, and/or
another challenge-response type authentication of the user, during which the data exchanged between the computer 102 and the identification electronic component 104n are encrypted using the first encryption key K₁ or another encryption key computed based on the challenge data of the identification electronic component 104n and the generated response data of the identification electronic component 104n obtained during said other challenge-response type authentication of the identification electronic component 104n.

Thus, the security of the system 100 is improved by the fact that the authenticity of the identification electronic component 104n and/or of the user is verified again after the first authentication of the user.

1. An electronic authentication system including a computer, a memory device connected to the computer, and a set of electronic components, the computer and the electronic components being connected together by direct or indirect links according to a predetermined configuration, each of the electronic components being provided with a PUF configured to apply a challenge-response type authentication protocol, wherein
the electronic system is configured to broadcast a unique challenge to the set of electronic components, and
the computer is configured to receive back from the set of electronic components at least one response enabling it to verify an integrity of the set of electronic components by comparing the at least one response with at least one expected response recorded beforehand in the memory device, the integrity of the set of electronic components being authenticated as being valid if the at least one response and the at least one expected response coincide.

2. The system according to claim 1, wherein the computer is configured to recover a set of individual responses from the set of electronic components and to compare it in a bijective manner with a set of expected individual responses specific to the challenge and to the set of electronic components.

3. The system according to claim 1, wherein the computer is configured to:
recover a set of individual responses from the set of electronic components,
compute a group response according to the set of individual responses, and
compare the group response with an expected group response.

4. The system according to claim 3, wherein a specific electronic component amongst the set of electronic components is configured to have a set of representative responses, in explicit or implicit manners, of the set of individual responses, enabling it to compute and transmit a group response to the computer which is configured to compare the group response with the expected group response.

5. The system according to claim 4, wherein the set of responses for the specific electronic component includes at least one intermediate group response computed by at least one other electronic component.

6. The system according to claim 3, wherein each of the electronic components is configured to have the set of individual responses enabling it to compute and transmit a group response to the computer which is configured to compare the group response received from any one of the electronic components with expected group response.

7. The system according to claim 1, wherein the system is configured to use a first encryption key to form a secure link between the computer and an identified electronic component amongst the set of electronic components, the computer being configured to transmit a user challenge to the identification electronic component using the secure link, the identified electronic component being configured to carry out a measurement on a user using the user challenge and to send, via the secure link, the response of the measurement to the computer which is configured to compare the response of the measurement with an expected identification response recorded beforehand by the memory device, the user being authenticated as valid if the response of the measurement corresponds to the expected identification response.

8. The system according to claim 7, wherein the computer is configured to compute the first encryption key based on the unique challenge and on an individual response of the identification electronic component.

9. The system according to claim 7, wherein the computer is further configured to:
compute a second encryption key based on the user challenge and the response of the measurement, the second encryption key being shared between the computer and the identification electronic component,
compute a third encryption key based on the first and second encryption keys, the second encryption key being shared between the computer and the identification electronic component, and
exchange encrypted data between the identification electronic component and the computer using the third encryption key.

10. The electronic system according to claim 1, wherein the memory device includes a database remote from the set of electronic components and from the computer.

11. The electronic system according to claim 1, wherein the set of electronic components and the computer form a portion of an electronic device corresponding to a smartphone, an electronic watch connected to the Internet, extended reality glasses connected to the Internet, or a vehicle.

12. The electronic system according to claim 1, wherein the set of electronic components and the computer are part of a set of electronic devices carried or used by a user.

13. The electronic system according to claim 1, wherein the set of electronic components and the computer are part of a set of electronic devices corresponding to a set of equipment in a vehicle.

14. The electronic system according to claim 1, wherein the electronic components correspond to memories held in a printed circuit board.

15. A challenge-response type authentication method, implemented in an electronic system according to claim 1.
